(19) United States
(12) Patent Application Publication
(10) Pub. No.: US 2025/0308813 A1
(43) Pub. Date: Oct. 2, 2025

(54) FUNCTION BUTTON ASSEMBLY FOR AN ELECTRICAL DEVICE

(71) Applicant: EATON INTELLIGENT POWER LIMITED, DUBLIN 4 (IE)

(72) Inventors: CHUANCHUAN ZHUANG, Shanghai (CN); ERIK J. GOUHL, Fayetteville, GA (US); LUIS F. SALAS, Peachtree City, GA (US)

(73) Assignee: EATON INTELLIGENT POWER LIMITED, DUBLIN 4 (IE)

(21) Appl. No.: 19/091,310

(22) Filed: Mar. 26, 2025

Related U.S. Application Data
(60) Provisional application No. 63/570,349, filed on Mar. 27, 2024.

(51) Int. Cl. H01H 13/14; H01R 13/713

(52) U.S. Cl. CPC H01H 13/14; H01R 13/7135

(57) ABSTRACT

Disclosed herein are electrical devices having a dual-layer button assembly configured to facilitate a straight path of button movement within the device in response to an external pushing force, including an eccentric or off-center force. A button assembly may include a TEST or RESET button for a ground fault circuit interrupter (GFCI) outlet. In one example, a dual-layer function button assembly may include an external button configured to receive a manual force to push the external button into the outlet and an external spring engaged with the bottom of the external button. An inner button may be arranged within the outlet, behind the external button, that is connected to components that initiate the associated function. The inner button may include an upper side configured to engage the bottom of the external button such that the external button pushes the inner button into the outlet.

### CROSS-REFERENCE TO RELATED APPLICATION

This application claims priority to U.S. Provisional Patent Application Ser. No. 63/570,349, filed on Mar. 27, 2024 and titled “DOUBLE-LAYER RESET BUTTON ASSEMBLY AND RECEPTACLE INCLUDING THE SAME,” the entire contents of which are incorporated herein by reference.

### TECHNOLOGICAL FIELD

The present disclosure is directed to an electrical device, such as an electrical outlet, and, in particular, to a double-layer function button assembly configured to initiate a function of the electrical device.

### BACKGROUND

Electrical devices may include one or more manual buttons provided for operators to initiate functions of the device. For example, the manual TEST and RESET functions of a ground fault circuit interrupter (GFCI) outlet are selected via corresponding physical buttons accessible through a front cover of the GFCI outlet. Electrical outlet manual buttons are typically embedded, at least partially, in a housing of the device, with an external portion accessible to the operator and configured to receive a manual force (i.e., pressing down on the button), and an internal portion configured to manipulate interior components of the electrical outlet to perform the selected function.

Due to the structural configuration and installation conditions of standard electrical outlets, manual buttons thereof are often subjected to eccentric or “off-center” forces that the manual buttons were not originally designed to handle. For example, when selecting a manual TEST and RESET button of a conventional GFCI outlet, an operator typically does not use a pushing force that is directed centrally on the button and/or in a straight path (i.e., at the center of mass of the selection surface of the button and in a straight path toward the back of the GFCI outlet). Such eccentric pushing forces cause torque, for instance, rotational and/or translational forces on the button (and components engaged with the button) within the housing. Strong and/or repeated torque on a manual button of an electrical outlet may lead to damaged and/or inoperative components, potentially impairing vital safety functions.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Disclosed herein are electrical devices having a dual-layer button assembly configured to facilitate a straight path of button movement within the device in response to an external pushing force, including an eccentric or off-center force. A button assembly may include a TEST or RESET button for a ground fault circuit interrupter (GFCI) outlet.

In one example embodiment, a GFCI outlet may include a frame and a dual-layer RESET button assembly configured to initiate a RESETTING operation when the GFCI outlet is in a TRIP state. The dual-layer RESET button assembly may include an external button assembly comprising an external button having a top side accessible through the frame and a bottom side, opposite the top side, arranged within the frame and operably engaged with an external spring, and an inner button assembly comprising an inner button having at least a portion arranged within the frame longitudinally below the external button, wherein the inner button comprises an upper side configured to engage at least a portion of the bottom side of the external button, a latch pin having a first end engaged with a lower side of the inner button and a second end, opposite the first end, engaged with a latch block, and an inner button spring wound around the latch pin.

In some embodiments of the GFCI outlet, the dual-layer RESET button assembly is configured to receive an external manual force at the top side of the external button to push the external button longitudinally downward into the frame to initiate the RESETTING operation, and longitudinal downward movement of the external button pushes the internal button assembly longitudinally downward into the frame in parallel.

In various embodiments of the GFCI outlet, the inner button is positioned closer to a lateral center of the frame compared with the external button.

In some embodiments of the GFCI outlet, the external button is formed with a ledge having a bottom ledge surface arranged on the bottom side of the external button, and the bottom ledge surface is configured to engage an upper contact surface of the upper side of the inner button.

In exemplary me embodiments of the GFCI outlet, the external manual force is an eccentric force causing a torque force on the external button, and the dual-layer function button assembly is configured to distribute at least a portion of the eccentric force from the external button to the upper side of the inner button.

In some embodiments of the GFCI outlet, the distribution of the at least a portion of the eccentric force causes the external button and the inner button assembly to move longitudinally downward within the frame in a straight path in parallel.

In various embodiments of the GFCI outlet, the external spring is configured to provide a longitudinally upward spring force on the external button as the external button moves longitudinally downward within the frame, the spring force operative to counteract the torque force on the external button.

In some embodiments of the GFCI outlet, the GFCI outlet further includes at least one set of separable contacts arranged within the frame and configured to be separated when the GFCI outlet is in the TRIP state, wherein the inner button assembly is configured to actuate a RESET mechanism, upon release of the external manual force from the external button, where the latch pin interfaces with the latch block and moves the latch block longitudinally via a return force of the inner button spring to cause the at least one set of separable contacts to close.

In exemplary embodiments of the GFCI outlet, the external button overlaps with about 30% to about 50% of the upper side of the inner button.

In various embodiments of the GFCI outlet, the GFCI outlet further includes at least one lead rail configured to guide longitudinal movement of at least one of the external button or the inner button within the frame in a straight path.

In one embodiment, a dual-layer function button assembly for initiating a function of an electrical device may include an external button assembly that includes an external button having a top side accessible through a frame of the electrical device and configured to receive an external manual force to push the external button longitudinally downward into the frame. The dual-layer function button assembly may include an external spring operably engaged with a bottom side of the external button. The dual-layer function button assembly may include an inner button assembly that includes an inner button having at least a portion arranged within the frame longitudinally below the external button, wherein the inner button includes an upper side configured to engage at least a portion of the bottom side of the external button, and is positioned closer to a lateral center of the frame compared with the external button.

In some embodiments of the dual-layer function button assembly, movement of the external button longitudinally downward into the frame causes the external button to engage the inner button to force corresponding movement of the inner button longitudinally downward into the frame in a straight path in parallel.

In some embodiments of the dual-layer function button assembly, the external button is formed with a ledge having a bottom ledge surface arranged on the bottom side of the external button, and the bottom ledge surface is configured to engage an upper contact surface of the upper side of the inner button.

In some embodiments of the dual-layer function button assembly, the external button overlaps with about 30% to about 50% of the upper side of the inner button.

In some embodiments of the dual-layer function button assembly, the external manual force is an eccentric force causing a torque force on the external button, and at least a portion of the eccentric force is distributed from the external button to the upper side of the inner button.

In some embodiments of the dual-layer function button assembly, the distribution of the at least a portion of the eccentric force causes the external button and the inner button assembly to move longitudinally downward within the frame in a straight path in parallel.

In some embodiments of the dual-layer function button assembly, the external spring is configured to provide a spring force on the external button as the external button moves laterally within the frame, the spring force operative to counteract the torque force on the external button.

In some embodiments of the dual-layer function button assembly, the electrical device is a ground fault circuit interrupter (GFCI) outlet, selection of the external button initiates a RESET operation of the GFCI outlet when the GFCI outlet is in a TRIP state, the inner button assembly further comprises a latch pin having a first end engaged with a lower side of the inner button and a second end, opposite the first end, engaged with a latch block, and an inner button spring wound around the latch pin, and the inner button assembly is configured to actuate a RESET mechanism, upon release of the external manual force from the external button, where the latch pin interfaces with the latch block and moves the latch block longitudinally via a return force of the inner button spring to cause the at least one set of separable contacts to close.

In one embodiment, a ground fault circuit interrupter (GFCI) outlet may include a frame and a dual-layer button assembly configured to initiate one of a TEST operation or a RESETTING operation. The dual-layer button assembly may include an external button assembly comprising an external button having a top side accessible through the frame and a bottom side, opposite the top side, arranged within the frame and operably engaged with an external spring, the external button configured to receive an external manual force to push the external button longitudinally downward into the frame. The dual-layer button assembly may include an inner button assembly comprising an inner button having at least a portion arranged within the frame longitudinally below the external button, wherein the inner button comprises an upper side configured to engage at least a portion of the bottom side of the external button. The dual-layer button assembly may include at least one lead rail configured to guide longitudinal movement of at least one of the external button or the inner button within the frame in a straight path. Movement of the external button longitudinally into the frame causes the external button to engage the inner button to force corresponding movement of the inner button longitudinally into the frame in the straight path in parallel.

In some embodiments of the GFCI outlet, the GFCI outlet may include a status indicator operably coupled to an outer side of the external button, the status indicator configured to prevent the external button from tilting toward the status indicator as the status indicator moves longitudinally downward within the frame.

In one embodiment, a ground fault circuit interrupter (GFCI) receptacle includes a cover having an inlet, a load conductor having a load contact; a receptacle conductor having a receptacle contact; a movable arm having movable contacts structured to connect or disconnect from the load and receptacle contacts, and a double-layer reset button assembly including an external reset button assembly and an inner reset button assembly, the external reset button assembly including an external reset button and an external reset spring disposed below the external reset button and structured to cause the external reset button to move longitudinally, the inner reset button assembly including an inner reset button disposed below the external reset button, a latch pin, an inner reset button spring wound around the latch pin, and a latch block, the inner reset button assembly being structured to reset the receptacle upon actuation of the reset mechanism thereof.

In one embodiment, a GFCI receptacle includes a frame having a cover and a bottom housing, the cover having an electrical inlet, a load conductor disposed on a side surface of the bottom housing and including a load contact; a receptacle conductor connected to the electrical inlet and having a receptacle contact; a movable arm connected to a trip mechanism and having movable contacts structured to connect to the load contact and the receptacle contact during normal operation and disconnect from the load contact and the receptacle contact based on a detection of a fault, and a double-layer reset button assembly including an external reset button assembly and an inner reset button assembly, the external reset button assembly including an external reset button and an external reset spring disposed below the external reset button and structured to cause the external reset button to move longitudinally upon applying or releasing an external force from the external reset button, the inner reset button assembly including an inner reset button disposed below the external reset button, a latch pin, an inner reset button spring wound around the latch pin, and a latch block, the inner reset button assembly being structured to reset the receptacle upon actuation of the reset mechanism thereof. Upon applying the external force on the external reset button, the external force is transmitted from the external reset button to the top surface of the inner reset button and distributed over the top surface of the inner reset button such that the external reset button and the inner reset button assembly move longitudinally downward in unison in a straight and balanced manner.

### BRIEF DESCRIPTION OF THE DRAWINGS

By way of example, features of the disclosed components and systems are described with reference to the accompanying drawings, in which:

FIG. 1 depicts an illustrative example of an electrical outlet including a double-layer function button assembly in accordance with the present disclosure;

FIG. 2 depicts an illustrative example of a double-layer function button assembly in accordance with the present disclosure;

FIG. 3 depicts a cross-sectional view of the illustrative example of an electrical outlet of FIG. 1 in accordance with the present disclosure;

FIG. 4 depicts an illustrative example of a TRIP state of an electrical outlet in accordance with the present disclosure;

FIG. 5 depicts an illustrative example of a RESETTING state of an electrical outlet in accordance with the present disclosure;

FIG. 6 depicts an illustrative example of a RESET state of an electrical outlet in accordance with the present disclosure;

FIG. 7 depicts an illustrative example of a travel path of a conventional electrical outlet function button; and

FIG. 8 depicts an illustrative example of a travel path of a double-layer function button assembly in accordance with the present disclosure.

### DETAILED DESCRIPTION

Various features of an improved function button assembly of an electrical device are described in the present disclosure, with reference to the accompanying drawings, in which one or more features of the function button assembly and the electrical device that includes the function button assembly are shown and described. The various features described in the present disclosure and depicted in the accompanying drawings may be used independently of, or in combination, with each other. A function button assembly and electrical device as disclosed herein may be embodied in many different forms and should not be construed as being limited to the examples set forth herein. Rather, these examples are provided to convey certain features of the function button assembly and electrical device to those skilled in the art.

In some embodiments, the electrical device may be or may include an electrical outlet. In various embodiments, the electrical device may be or may include a ground fault circuit interrupter (GFCI) outlet. Although examples of the present disclosure include an electrical device in the form of an electrical outlet or a GFCI outlet, embodiments are not so limited, for instance, the function button assembly and/or components thereof may be used with other existing or future-developed electrical devices.

In various embodiments, the function button assembly may be used for a function of an electrical outlet. In various embodiments, the function button assembly may be used for a function of a GFCI outlet. In one example, the function button assembly may be a reset button assembly used for a RESET function of a GFCI outlet. In another example, the function button assembly may be a test button assembly used for a TEST function of a GFCI outlet. Although examples of the present disclosure include a function button assembly for a function of an electrical outlet, including GFCI outlet TEST and/or RESET functions, embodiments are not so limited, for instance, the function button assembly and/or components thereof may be used with other existing or future-developed electrical devices and/or functions.

In some embodiments, the function button assembly may be or may include a double-layer button assembly configured to be installed within a frame or housing of an electrical device, such as an electrical outlet. The double-layer button assembly may be associated with one or more specific functions of the electrical device. For example, the double-layer button assembly may be configured to initiate a RESET function and/or a TEST function of a GFCI outlet. For instance, an operator may manually press the double-layer button assembly to cause the electrical device to perform the associated function(s).

In various embodiments, the double-layer button assembly may include an external button and an inner button. The external button is configured to be manually pushed by an operator, for instance, into (or further into) the housing of the electrical device. The external button may be configured to engage an inner button that is arranged below at least a portion of the external button within the housing. The inner button may be positioned more centrally with respect to the housing compared with the external button. For example, the inner button may be arranged in the center of the housing or closer to the center of the housing compared with the external button. As the external button is pushed into (or further into) the housing, the external button engages the inner button such that movement of the external button causes the inner button to be pushed into the housing in unison, in parallel, or otherwise simultaneously (or substantially simultaneously). The inner button may be operably coupled to or in contact with components, for instance, pins, springs, latches, blocks, and/or the like, operated to perform the associated function. Additional mechanisms, such as one or more guide or lead rails, may be included to further guide the longitudinal movement of the function buttons and/or components thereof.

The double-layer button assembly of the described embodiments may provide multiple technological advantages over existing manual button configurations for electronic devices. In one non-limiting technological advantage, any central, non-eccentric manual force exerted on the external button is transferred to move the inner button (in a straight, non-eccentric path), which actually triggers the associated function. Therefore, the inner button is not subjected to the eccentric forces of the external button caused by eccentric operator pushing forces, particularly in a manner that causes torque force(s) on the inner button and/or components operably engaged with the inner button. The double-layer function button configuration of various embodiments prevents the torque generated by an eccentric external pressing force at any position from being transmitted to the inner button, allowing the inner button to maintain straight (non-torsional and/or non-rotational) movement. In another non-limiting technological advantage, the double-layer function button configuration of various embodiments prevents damage to components, increases the life of the electrical device, and, in the case of circuit interrupter operations, maintains vital safety systems. In a further non-limiting technological advantage, the double-layer function button configuration may include one or more guide rails to prevent torsional and/or rotational movement during button travel and to guide the longitudinal movement of the function buttons and/or components thereof. Embodiments are not limited to the aforementioned technological advantages, for example, as those of skill in the art would recognize additional technological advantages of the embodiments described in the present disclosure.

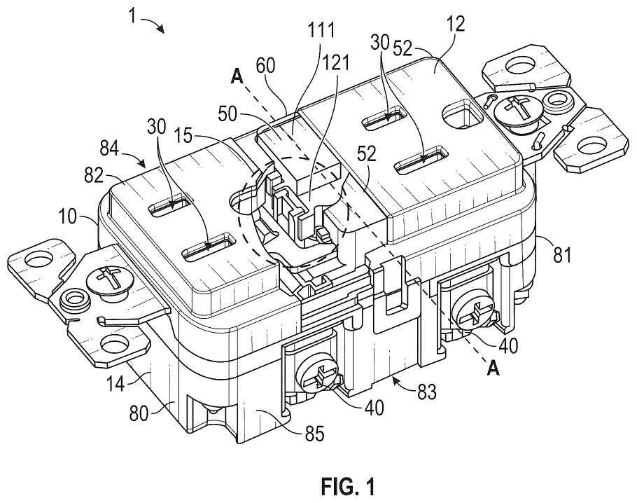

FIG. 1 depicts an illustrative example of an electrical outlet including a function button assembly in accordance with the present disclosure. The electrical outlet components are depicted in FIG. 1 for illustrative purposes. Electrical outlets and components thereof in accordance with the present disclosure may include more or fewer components and/or may be arranged in a different configuration.

As shown in FIG. 1, an electrical outlet 1 may be or may include a GFCI outlet. The GFCI outlet 1 may include a housing or frame 10 formed of a cover 12 and a bottom housing 14. In various embodiments, a middle housing may be arranged between the cover 12 and the bottom housing 14. The cover 12 may include electrical slots, outlets, or electrical inlets 30 configured to receive corresponding prongs of a prong connector or plug. Although the present disclosure, including FIG. 1, describes the GFCI outlet 1 as having double outlets 30, embodiments are not so limited, as this configuration is for illustrative purposes only. For example, the GFCI outlet 1 may include more or fewer electrical outlets 30. The GFCI outlet 1 may include one or more terminals 40, such as load terminals and line terminals for coupling the GFCI outlet 1 to corresponding load and line connections.

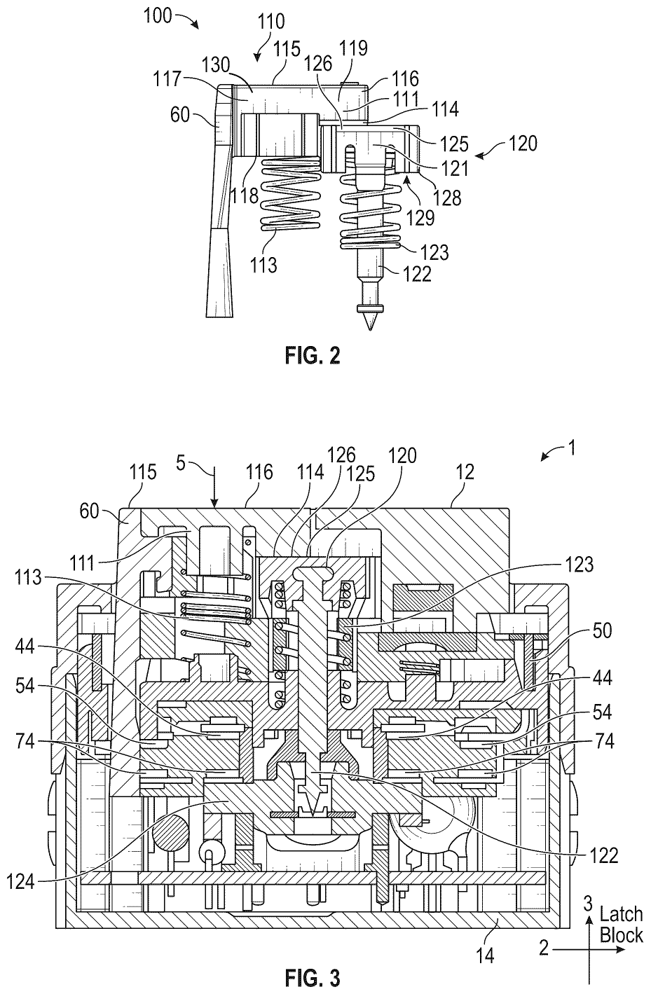

The GFCI outlet 1 may include one or more function buttons (or actuators), such as a RESET button 50 and/or a TEST button 52. In some embodiments, one or more of the buttons 50 or 52 may be or may be associated with a function button assembly according to the present disclosure (see, for example, FIGS. 2 and 3). In some embodiments, the GFCI outlet 1 may also include a status indicator 60 configured to indicate one or more states of the GFCI outlet 1. For example, and without limitation, the status indicator 60 may include an LED light configured to indicate if the GFCI outlet 1 is in a TRIP, RESETTING, and/or RESET (normal) state.

In the present disclosure, the sides of the GFCI outlet I are described with reference to a typical installation, with a top side 80, a bottom side 81, a front side 82, a back side 83, a first longitudinal (or right) side 84, and a second longitudinal (or left) side 85. The sides 80-85 are for non-limiting reference to describe directionality of certain components and/or operations of the embodiments, for example, a GFCI outlet 1 may be installed in a different configuration in which side 80 is the bottom and side 81 is the top.

In addition, in the present disclosure, the relative positions and movements of components are described with references to a longitudinal axis and a lateral axis orthogonal to the longitudinal axis 3 (see the longitudinal axis 3 and the lateral axis 2 as depicted in FIG. 3). The term “longitudinally higher” means longitudinally closer to the cover 12 and “longitudinally lower” means longitudinally further away from the cover 12. In a typical installation configuration, longitudinally lower may be “behind” from the perspective of an external viewer viewing the cover 12. Moving “longitudinally upward” means moving longitudinally toward the cover 12 (and away from the bottom housing 14). In a typical installation configuration, longitudinally upward may be “in front of” from the perspective of an external viewer viewing the cover 12. Moving “longitudinally downward” means moving longitudinally away from the cover 12 (and toward the bottom housing 14). Moving longitudinally 3 generally indicates movement from front to back (e.g., from the front side 82 to the back side 83), or vice versa. Moving laterally 2 generally indicates movement from right to left (e.g., from the first longitudinal (or right) side 84 to the second longitudinal (or left) side 85), or vice versa.

FIG. 2 depicts an illustrative example of a function button assembly in accordance with the present disclosure. FIG. 3 depicts an illustrative cross-sectional view of the GFCI outlet of FIG. 1 sectioned across line A-A of FIG. 1.

With reference to FIGS. 1, 2, and 3, the GFCI outlet 1 may include a double-layer button assembly 100. In various embodiments, the double-layer button assembly 100 may be configured as a RESET button for the GFCI outlet 1 to perform a RESET or RESETTING operation. The double-layer button assembly 100 may include an external button assembly 110 and an inner button assembly 120.

The external button assembly 110 may include an external button 111 accessible from the front side 82 of the GFCI outlet 1. The external button 111 may have a portion accessible through the cover 12 and a portion embedded within the internal portion of the frame 10. The external button 111 may include a top side 115 configured to be pressed by an operator, a bottom side 118, an inner side 116 (closer to the second longitudinal (or left) side 85 and the center of the frame 12), and an outer side 117 (closer to the first longitudinal (or right) side 84 and further from the center of the frame 12) compared with the inner side 116). An operator initiates a function by selecting the double-layer button assembly 100 by pressing the external button 111. The external button 111 may be actuatable longitudinally (i.e., into or further into the frame 10 in a direction from the front side 82 to the back side 83). Selection of the external button 111 (i.e., via an operator pushing on the external button 111) may cause the external button 111 to travel longitudinally within the frame 10 (i.e., into or further into the frame 10), for instance, in a direction from the front side 82 toward the back side 83.

An external button spring 113 may be arranged longitudinally below the external button 111, for example, in contact with the bottom side 118. The external button 111 may be configured to engage the external button spring 113. Manual selection of the external button 111 pushes the external button 111 longitudinally into or further into the frame 10. Movement of the external button 111 longitudinally causes compression of the external button spring 113.

Movement of the external button 111 longitudinally down causes corresponding longitudinally downward movement of portions of the external button spring 113 (i.e., the top portion moves longitudinally downward, while the bottom portion remains stationary, thereby compressing the external button spring 113).

In some examples, the external button spring 113 is arranged and configured to balance the external button 111. For example, the external button spring 113 may be configured to provide an upward spring force on the external button 111 that counteracts, reduces, or even eliminates (or “cancels out”) various torque forces on the external button 111. In some embodiments, the external button spring 113 may be disposed off-center with respect to the external button 111. For example, the center of the external button spring 113 may be arranged closer to the inner side 116 compared with the outer side 117, while still being below the external button 111, in order to counteract torque forces on the inner side 116 compared with the outer side 117.

The inner button assembly 120 includes an inner button 121 disposed longitudinally below (or behind, when viewing an installed GFCI outlet 1) at least a portion of the external button 111. The external button 111 and inner button 121 are depicted in FIG. 1 visible through a cut-out region 15 of the cover 12. The inner button 121 may be positioned more centrally with respect to the frame 12 compared with the external button 111. For example, the inner button 121 may be positioned closer to a lateral center of the frame (e.g., a center defined between the first longitudinal (or right) side 84 and the second longitudinal (or left) side 84).

The inner button assembly 120 includes a latch pin 122 extending longitudinally downward and an inner button spring 123 wound around the latch pin 122. In some embodiments, the inner button spring 123 and/or the latch pin 122 may engage or be coupled to the inner button 121 within a button cavity 129. For example, the inner button spring 123 and/or the latch pin 122 may engage or be coupled to the inner button 121 on an underside of the upper side 125 within the button cavity 129.

In various embodiments, the inner button 121 may be operatively coupled to a latch block 124 configured that is configured to interface with the latch pin 122 and cause separable contacts 44, 54, and 74 to close via the spring force of the inner button spring 123. The separable contacts 44, 54, and 74 are configured to be engaged, in contact, or otherwise “closed” during normal operation of the GFCI outlet 1 and to be disengaged, separated, or otherwise “opened” or “tripped” when the GFCI outlet 1 is in a fault condition (i.e., in a TRIP state).

The inner button 121 includes an upper side 125 and a lower side 128, opposite the upper side 125. At least a portion of the upper side 125 is configured to engage at least a portion of the bottom side 118 of the external button 111. In some embodiments, the external button 111 may be formed with a ledge 119 having a bottom ledge surface 114 that is longitudinally higher than the lowest portion of the bottom side 118. The external button 111 may be configured to engage the inner button 121 via the ledge 119. For example, the bottom ledge surface 114 may be configured to engage an upper contact surface or portion 126 of the upper side 125 of the inner button 121. Accordingly, when the external button 111 travels longitudinally downward into the GFCI outlet 1, only a portion (i.e., bottom ledge surface 114) of the external button 111 engages and pushes on a portion of the inner button (i.e., upper contact surface 126). In some embodiments, the inner button 121 may be longitudinally separate from the bottom surface of the external button 111.

The size or portion of the ledge 119 may vary according to some embodiments. In one non-limiting example, the ledge 119 may be about 25% to about 50% of the entire length of the external button 111, for instance, the length of the bottom side 118. In some non-limiting examples, the ledge 119 may be about 10%, about 20%, about 25%, about 30%, about 33%, about 50%, about 75%, about 90%, or any value or range between any two of these aforementioned values (including endpoints) of the length of the external button 111. In some embodiments, the external button 111 may not have a ledge 119.

The length or portion of the overlap between the external button 111 (or the ledge 119 thereof) and the inner button 121 may vary according to some embodiments. In one non-limiting example, the external button 111 (or the ledge 119 thereof) may overlap about 25% to about 50% of the upper side 125 of the inner button 121. In some non-limiting examples, the external button 111 (or the ledge 119 thereof) may overlap with about 10%, about 20%, about 25%, about 30%, about 33%, about 50%, about 75%, about 90%, or any value or range between any two of these aforementioned values (including endpoints) of the upper side 125 of the inner button 121.

Upon application of an external force (i.e., an operator pressing the external button 111), the external force (centric or eccentric) is transmitted to and distributed to or over at least a portion of the upper side 125 of the inner button 121. The distributed external force then causes the inner button 121 to move longitudinally in a straight, stable manner. As such, the double-layered separate buttons 111 and 121 allow the inner reset button assembly 100 to move longitudinally in a straight, stable manner without having the torque generated by the eccentric force passed onto the inner button assembly 100.

In some embodiments, the GFCI outlet 1 may include a status indicator (for example, without limitation, LEDs) 60. In various embodiments, the status indicator 60 may include a light pipe or similar structure that extends longitudinally into the frame 10. In exemplary embodiments, the status indicator 60 may be arranged on a side of the external button 111, such as on an outer side 117 of the external button 111. In various embodiments, the status indicator 60 may be coupled to the external button 111, for instance, such that the external button 111 and status indicator move longitudinally in parallel or unison. In some embodiments, the status indicator 60 may be arranged and/or configured to prevent the external button 111 from tilting toward the status indicator 60 as a result of the eccentric force.

Accordingly, in some embodiments, a user interacts with the external button 111. However, contrary to conventional systems, the external button 111 does not directly cause the resulting operation (i.e., initiating a RESET function). For instance, the external button 111 is not coupled or does not directly intreact with internal components that perform a function (e.g., the latch pin, inner button spring 123, the latch block 124 etc.). Instead, pushing of the external button 111 causes the external button 111 to actuate another button, the inner button 121, that directly operates function components (e.g., the latch pin, inner button spring 123, the latch block 124 etc.). Separation of the button that is pushed by an operator (i.e., external button 111) from the inner button (i.e., inner button 121) that directly operates function components facilitates the management of eccentric forces according to embodiments of the present disclosure.

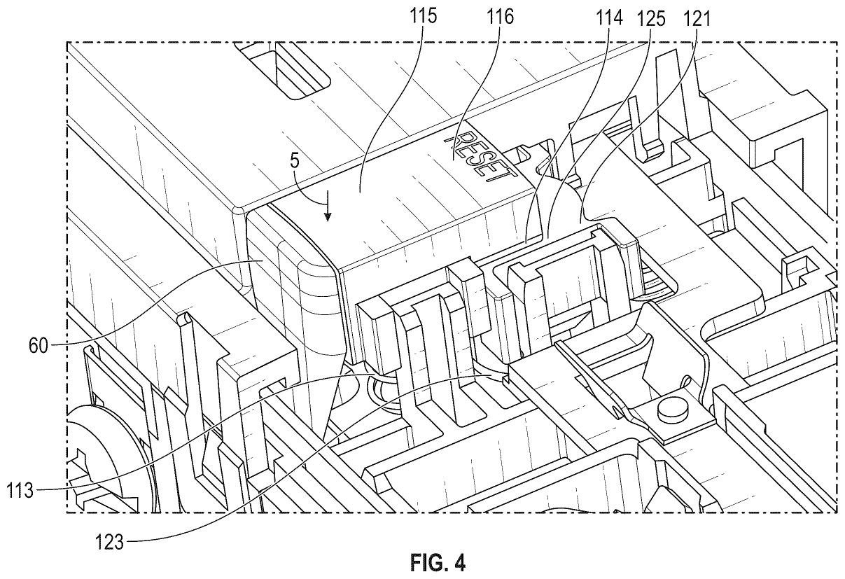

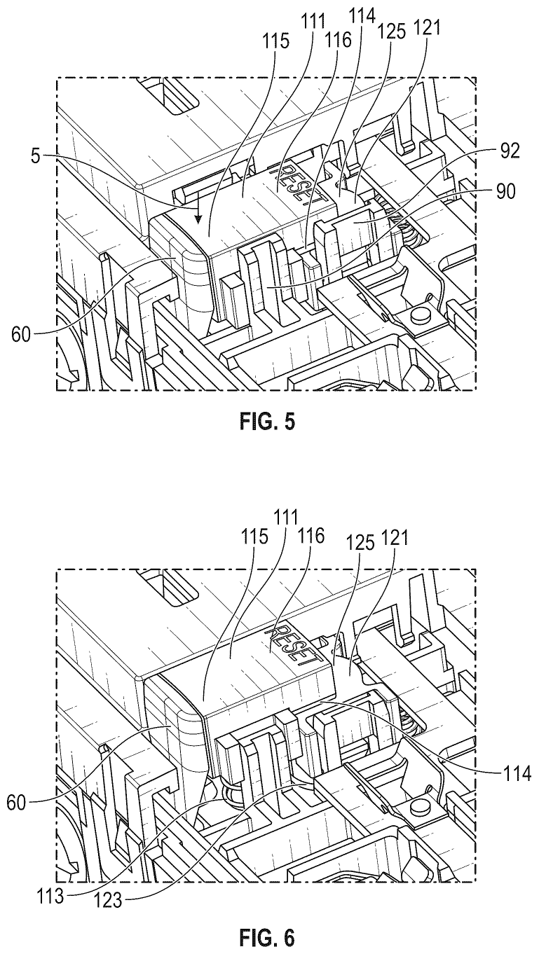

FIGS. 4-6 depict illustrative examples of certain states of the electrical outlet in accordance with the present disclosure. More specifically, FIG. 4 depicts a TRIP state, FIG. 5 depicts a RESETTING state, and FIG. 6 depicts a RESET (or normal operating condition) state of the electrical outlet in accordance with the present disclosure.

With reference to FIGS. 3-6, in operation, in order to reset the GFCI outlet 1 in the TRIP state, an external force 5 is applied to the external button 111, for instance, via an operator pressing on the external button 111. Actuation of the external button 111 initiates a RESETTING state or operation. In the example of FIGS. 4-6, the external force 5 is an eccentric force. The eccentric force 5 is transmitted and evenly distributed over the upper side 125 of the inner button 121, causing the inner button 121 to move longitudinally downward in a straight manner without being affected by the torque (i.e., reducing or even eliminating rotational or torsional motion). As such, upon applying the external force 5, the external button 111, the inner button 121, and the status indicator 60 move longitudinally downward in unison.

In some embodiments, the GFCI outlet 1 may include one or more guard or lead rails configured to guide longitudinal travel of the external button 111, inner button 121, and/or components thereof. Referring to FIG. 5, a first lead rail 90 may extend longitudinally and may be disposed adjacent to a second side 130 of the external button 111, the second side being orthogonal to the top side 115. The first lead rail 90 is structured to guide longitudinal movement of the external button 111 and prevent the external button 111 from tilting in a direction toward the first lead rail 90 in response to the eccentric force 5. In various embodiments, the GFCI outlet 1 further includes a second lead rail 92 disposed on a side of the inner button 121 adjacent to the first lead rail 90. The second lead rail 90 is structured to guide longitudinal movement of the inner reset button 111. The second lead rail 92 prevents the inner reset button 111 from tilting in a direction toward the second lead rail 92 when the eccentric force 5 is applied.

Referring to FIG. 5, in the RESETTING state, the external button 111 and the inner button 121 move longitudinally in unison along the lead rails 90 and 92. The latch pin 122 moves downward without being affected by the torque generated by the eccentric force 5, and upon releasing of the eccentric force 5, the reset mechanism is actuated. For example, upon releasing of the eccentric force 5, the latch pin 122 interfaces with the latch block 124 and moves the latch block 124 longitudinally upward via the return force of the inner button spring 123. The latch block 124 in turn forces a movable arm (not shown) to move longitudinally upward to cause the separable contacts 44, 54, and 74 to close. Upon returning of the external button 111 to the unactuated position, the reset mechanism is terminated and, as shown in FIG. 6, the GFCI outlet 1 is in the RESET state.

Accordingly, by including the double-layer reset button assembly and additional counter measuring mechanisms, the GFCI outlet 1 effectively reduces or even eliminates any torque generated by an eccentric force applied via manual forces on a function button, thereby allowing the components of the button assembly 100 to move longitudinally in a straight, stable, and balanced manner regardless of the strength and/or position of the eccentric force being applied.

FIG. 7 depicts an illustrative example of a travel path of a conventional electrical outlet function button. As shown in FIG. 7, a conventional electrical outlet function button, such as a RESET button of a conventional GFCI outlet, is a single-button configuration having an external button 700 attached to the components used to perform the function, such as a latch pin 701 and a spring 702. Latch pin 701 may be similar to latch pin 122 and spring 702 may be similar to inner button spring 123. Selection of external button 700 directly initiates the associated function, such as a RESETTING operation. If an operator presses on the external button 700 with a straight, linearly acting, or non-eccentric force (i.e., a force that acts along a straight line) 711, then external button 700 may travel along a straight path 712 into the electrical outlet. However, if the user presses on the button with a non-straight, non-linearly acting, or eccentric force 710, then the external button 700 may be subjected to torque forces and travel, at least partially, along an eccentric path 713. Strong and/or repeated torque on the external button 700 due to the eccentric force 710 may lead to damaged and/or inoperative components, potentially impairing vital safety functions.

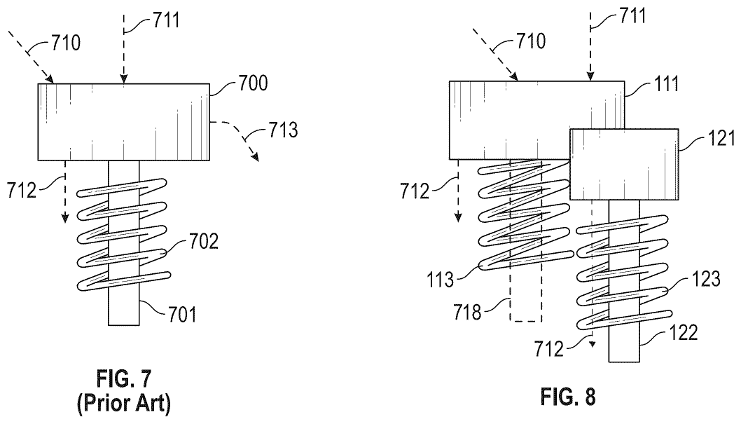

FIG. 8 depicts an illustrative example of a travel path of a double-layer function button assembly in accordance with the present disclosure. As shown in FIG. 8, in some embodiments, the external spring 113 may be arranged around a pin 718 coupled to or engaged with the external button 111 (e.g., the bottom side 118). The pin 718 may serve to guide or restrict the movement of the external spring 113 laterally within the frame, for example, to hold the external spring 113 in place and ensure that the external spring 113 moves (or compresses) longitudinally.

Referring to FIG. 8, if an operator presses on the external button 111 with a straight, linearly acting, or non-eccentric force (i.e., a force that acts along a straight line) 711, then the external button 111 and the inner button 121 will travel along a straight path 712 into the electrical outlet. However, if the user presses on the external button 111 with a non-straight, non-linearly acting, or eccentric force 710, then the double-layer button assembly 100 will convert this force, via the dual-button configuration and/or lead rails (i.e., lead rails 90 and 92), into a straight, linearly acting, or non-eccentric travel path 712 for both the external button 111 and the inner button 121 as they travel longitudinally within the frame 10. In this manner, the double-layer button assembly 100 is able to prolong the life of an electronic device, such as a GFCI outlet, and components thereof.

While specific embodiments have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A ground fault circuit interrupter (GFCI) outlet, comprising:
a frame; and
a dual-layer RESET button assembly configured to initiate a RESETTING operation when the GFCI outlet is in a TRIP state, the dual-layer RESET button assembly comprising:
an external button assembly comprising an external button having a top side accessible through the frame and a bottom side, opposite the top side, arranged within the frame and operably engaged with an external spring, and
an inner button assembly comprising an inner button having at least a portion arranged within the frame longitudinally below the external button, wherein the inner button comprises an upper side configured to engage at least a portion of the bottom side of the external button, a latch pin having a first end engaged with a lower side of the inner button and a second end, opposite the first end, engaged with a latch block, and an inner button spring wound around the latch pin.

2. The GFCI outlet of claim 1, wherein
the dual-layer RESET button assembly is configured to receive an external manual force at the top side of the external button to push the external button longitudinally downward into the frame to initiate the RESETTING operation, and
longitudinal downward movement of the external button pushes the internal button assembly longitudinally downward into the frame in parallel.

3. The GFCI outlet of claim 2, wherein the inner button is positioned closer to a lateral center of the frame compared with the external button.

4. The GFCI outlet of claim 2, wherein:
the external button is formed with a ledge having a bottom ledge surface arranged on the bottom side of the external button, and
the bottom ledge surface is configured to engage an upper contact surface of the upper side of the inner button.

5. The GFCI outlet of claim 2, wherein:
the external manual force is an eccentric force causing a torque force on the external button, and
the dual-layer function button assembly is configured to distribute at least a portion of the eccentric force from the external button to the upper side of the inner button.

6. The GFCI outlet of claim 5, wherein the distribution of the at least a portion of the eccentric force causes the external button and the inner button assembly to move longitudinally downward within the frame in a straight path in parallel.

7. The GFCI outlet of claim 5, wherein the external spring is configured to provide a longitudinally upward spring force on the external button as the external button moves longitudinally downward within the frame, the spring force operative to counteract the torque force on the external button.

8. The GFCI outlet of claim 1, further comprising at least one set of separable contacts arranged within the frame and configured to be separated when the GFCI outlet is in the TRIP state,
wherein the inner button assembly is configured to actuate a RESET mechanism, upon release of the external manual force from the external button, where the latch pin interfaces with the latch block and moves the latch block longitudinally via a return force of the inner button spring to cause the at least one set of separable contacts to close.

9. The GFCI outlet of claim 1, wherein the external button overlaps with about 30% to about 50% of the upper side of the inner button.

10. The GFCI outlet of claim 1, further comprising at least one lead rail configured to guide longitudinal movement of at least one of the external button or the inner button within the frame in a straight path.

11. A dual-layer function button assembly of an electrical device, comprising:
an external button assembly comprising:
an external button having a top side accessible through a frame of the electrical device and configured to receive an external manual force to push the external button longitudinally downward into the frame, and
an external spring operably engaged with a bottom side of the external button; and
an inner button assembly comprising:
an inner button having at least a portion arranged within the frame longitudinally below the external button, wherein the inner button:
comprises an upper side configured to engage at least a portion of the bottom side of the external button, and
is positioned closer to a lateral center of the frame compared with the external button.

12. The dual-layer function button assembly of claim 11, wherein movement of the external button longitudinally downward into the frame causes the external button to engage the inner button to force corresponding movement of the inner button longitudinally downward into the frame in a straight path in parallel.

13. The dual-layer function button assembly of claim 11, wherein:
the external button is formed with a ledge having a bottom ledge surface arranged on the bottom side of the external button, and
the bottom ledge surface is configured to engage an upper contact surface of the upper side of the inner button.

14. The dual-layer function button assembly of claim 11, wherein the external button overlaps with about 30% to about 50% of the upper side of the inner button.

15. The dual-layer function button assembly of claim 11, wherein:
the external manual force is an eccentric force causing a torque force on the external button, and
at least a portion of the eccentric force is distributed from the external button to the upper side of the inner button.

16. The dual-layer function button assembly of claim 15, wherein the distribution of the at least a portion of the eccentric force causes the external button and the inner button assembly to move longitudinally downward within the frame in a straight path in parallel.

17. The dual-layer function button assembly of claim 15, wherein the external spring is configured to provide a spring force on the external button as the external button moves laterally within the frame, the spring force operative to counteract the torque force on the external button.

18. The dual-layer function button assembly of claim 11, wherein:
the electrical device is a ground fault circuit interrupter (GFCI) outlet,
selection of the external button initiates a RESET operation of the GFCI outlet when the GFCI outlet is in a TRIP state,
the inner button assembly further comprises a latch pin having a first end engaged with a lower side of the inner button and a second end, opposite the first end, engaged with a latch block, and an inner button spring wound around the latch pin, and
wherein the inner button assembly is configured to actuate a RESET mechanism, upon release of the external manual force from the external button, where the latch pin interfaces with the latch block and moves the latch block longitudinally via a return force of the inner button spring to cause the at least one set of separable contacts to close.

19. A ground fault circuit interrupter (GFCI) outlet, comprising:
a frame; and
a dual-layer button assembly configured to initiate one of a TEST operation or a RESETTING operation, the dual-layer button assembly comprising:
an external button assembly comprising an external button having a top side accessible through the frame and a bottom side, opposite the top side, arranged within the frame and operably engaged with an external spring, the external button configured to receive an external manual force to push the external button longitudinally downward into the frame, and
an inner button assembly comprising an inner button having at least a portion arranged within the frame longitudinally below the external button, wherein the inner button comprises an upper side configured to engage at least a portion of the bottom side of the external button, and
at least one lead rail configured to guide longitudinal movement of at least one of the external button or the inner button within the frame in a straight path,
wherein movement of the external button longitudinally into the frame causes the external button to engage the inner button to force corresponding movement of the inner button longitudinally into the frame in the straight path in parallel.

20. The GFCI outlet of claim 19, further comprising a status indicator operably coupled to an outer side of the external button, the status indicator configured to prevent the external button from tilting toward the status indicator as the status indicator moves longitudinally downward within the frame.
